(19) United States
(12) Patent Application Publication
(10) Pub. No.: US 2003/0102975 A1
(43) Pub. Date: Jun. 5, 2003

(54) Pay and display parking machine with user detector

(75) Inventor: Yvon Hache, Dieppe (CA)

Correspondence Address: Norman P. Soloway, HAYES SOLOWAY P.C., 130 W. Cushing Street, Tucson, AZ, 85701, US

(73) Assignee: J.J. MACKAY CANADA LIMITED

(21) Appl. No.: 10/307,629

(22) Filed: Dec. 2, 2002

Related U.S. Application Data
(60) Provisional application No. 60/334,925, filed on Dec. 4, 2001.

(51) Int. Cl. G08B 21/00

(52) U.S. Cl. 340/686.6; 368/90; 340/932.2; 705/418

(57) ABSTRACT

A parking machine and a method of operating the parking machine are described. The parking machine includes a controller, a display controlled by the controller and a presence sensor for detecting the presence of a person in the vicinity of the parking machine. The method of operating the parking machine comprises detecting the presence of a person in the vicinity of the parking machine, placing the parking machine into an operating mode when the presence is detected, and returning the parking machine into the sleep mode once the person is no longer detected in the vicinity of the parking machine. When placed in the operating mode, the display shows the unexpired real parking time for parking spaces associated with the parking machine and/or shows instructions for a user to purchase parking time.

This application claims the benefit of U.S. Provisional Patent Application Serial No. 60/334,925 filed on Dec. 4, 2001.

### FIELD OF THE INVENTION

The invention relates generally to the pay and display parking machines and more particularly to a parking machine that is automatically activated in the presence of a user.

### BACKGROUND OF THE INVENTION

A Pay and Display Parking Machine is basically a pay by space machine, which is a type of multi-space parking control device found in many cities of the world to control on-street or off-street (parking lots) parking spaces. It is usually much larger than a parking meter as it manages payments and acknowledgements of payment for many parking spaces. Features usually include a printer for receipt and ticket issue, a facility for payment by credit card, cash or smart card, a coin return, a large graphic display, a cash vault, a solar panel, a large data storage capability, advanced communications/on-line facilities, rate structure control, and software features for control of all of above.

The Pay and Display machine (PDM) uses the graphic display, which may be a Liquid Crystal Display (LCD) to indicate the current real time for a user as well as to provide user instructions for the purchase of a parking ticket. Since some PDM installations run on solar and/or battery power, the amount of power consumed is critical to insure continuous operation over a long period of time.

In order to save energy consumption, the PDM's Main Controller Board (MCB) can turn off the peripherals, including the LCD, when there are no activities on the PDM. In some cases the machine must provide a “continuous” display of the current real time for users without someone having to interact with the machine or to press a button. To achieve this and limit the power demand at the same time, many multi-parking control devices have two separate displays, one for the continuous display of the time and the other for the display of graphic messages and instructions for the user to interact with the parking machine. This is costly in terms of components, is not very efficient when there are no users in the vicinity, and the extra display is an additional target for vandals. Another disadvantage of such a parking machine is that when a user approaches the parking control device, there are no instructions displayed on the LCD that tell the user what steps to take to initiate the purchase of time for parking.

Therefore, there is a need for a parking control device wherein the parking machine and/or display is activated when required by a user.

### SUMMARY OF THE INVENTION

The invention is directed to a method of operating a parking machine that is in a sleep or low power mode when not activated. The method comprises detecting the presence of a person in the vicinity of the parking machine, placing the parking machine into an operating mode, and returning the parking machine into the sleep mode once the person is no longer detected in the vicinity of the parking machine. The method may further include receiving instructions from the person when the parking machine is in the operating mode. Some or all peripherals of the parking machine may initially be placed into the operating mode when a person is detected. In a parking machine having a display, the display may be placed into the operating mode to display the unexpired real parking time for parking spaces associated with the parking machine and/or to display instructions for the purchase of parking time.

In accordance with a specific aspect of the invention, the presence of a person in the vicinity of the parking machine is detected for at least a predetermined short period of time before the parking machine goes into the operating mode, and the parking machine is returned into the sleep mode a further short predetermined period of time after the person is no longer detected.

In accordance with a further aspect of this invention, a parking machine adapted to be in a sleep mode when not activated comprises a sensor for detecting the presence of a person in the vicinity of the parking machine, a controller for placing the parking machine into an operating mode in response to a detected person and for returning the parking machine into the sleep mode once the person is no longer detected in the vicinity of the parking machine. The parking machine may further include an interface for receiving instructions from the person to operate the parking machine.

In accordance with another aspect of this invention, a parking machine comprises a controller, a display controlled by the controller and a presence sensor coupled to the controller for detecting the presence of a person in the vicinity of the parking machine to place the display into an operating mode. The controller includes a first control element for placing the display into a sleep mode when the presence of a person is not detected and a second control element for placing the display into an operating mode when the presence of a person is detected.

In accordance with a further aspect of this invention, the parking machine further comprises a number of peripherals coupled to the controller whereby the controller also places the peripherals into the operating mode when the presence of a person is detected and into the sleep mode when the presence of a person is no longer detected.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawing, wherein:

FIG. 1 is a schematic of the pay and display parking machine in accordance with the present invention.

### DETAILED DESCRIPTION OF THE INVENTION

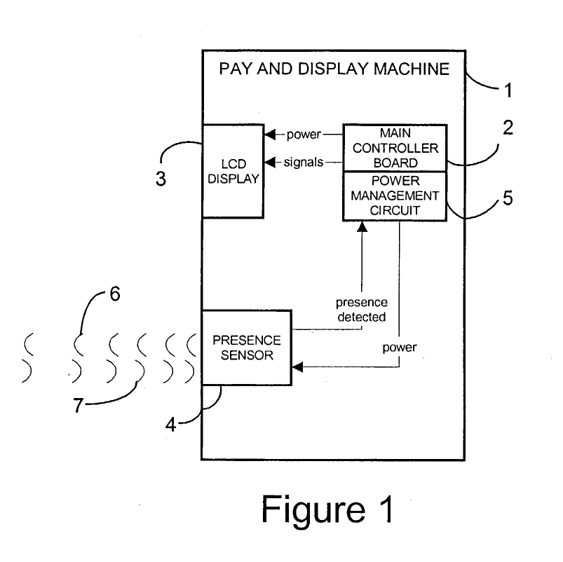

FIG. 1 schematically illustrates a parking machine 1 in accordance with the present invention. The Pay and Display parking machine 1 includes a main controller 2 coupled to a display 3 which may be an LCD. In addition, the parking machine will have one or more further peripherals that are also coupled to the main controller 2, these may include a printer for receipt and ticket issue, a facility for payment by credit card, cash or smart card, a coin return, a cash vault and a keypad interface. These peripherals have not been shown to simplify the drawing. A power management circuit 5, which is coupled to a power source (not shown) such as a battery/solar cell array, manages the power use of the parking machine under the control of the main controller 2, as described below.

The display 3 is adapted to show the current real parking time that a user has for her/his parking space as well as all of the instructions for purchasing a parking ticket from the parking machine. Such a parking machine 1 is more versatile and easier to use as it can work in various languages without having to have all of the various instructions in multiple languages printed on its front panel.

In addition, the parking machine 1 includes a presence sensor 4 strategically positioned on the parking machine 1 to be able to detect a person that is approaching the parking machine 1. The sensor 4 would normally be located on the front of the parking machine 1, however, one or more sensors may also be positioned at other locations. The sensor 4 is preferably a type of sensor that uses very little power. The sensitivity of the sensor 4 can be adjusted to detect a person up to in the order of 10 feet from the sensor 4 on front of the parking machine 1. One type of sensor 4, which may be used with the present invention, is an IR8002 presence sensor from Infrared of New Jersey Inc., 77 East Halsey Road, Parsippany, N.J., 07054, USA (www.imi.com). This type of sensor 4 sends out a pulsed infrared signal 6 and looks for a reflection 7. When the sensor 4 receives a reflection 7 of its transmitted signal 6, it provides an output signal to the power management circuit 5, which wakes up the controller 2. The controller 2 controls the display 3 and all of the other peripherals in the parking machine 1.

The power management circuit 5 is an electronic circuit with a low power microcontroller that can turn on and off any peripherals under commands coming from the main controller 2. The power management circuit 5 microcontroller also goes into the sleep mode with the rest of the parking machine 1. It wakes-up periodically and frequently to check various sensors including a presence sensor 4. If the presence of a person near the parking machine 1 is detected, the microcontroller wakes-up the main controller 2 and waits for a command from the main controller 2 to power up the display 3 and other peripherals. The power management circuit 5 is connected to the main controller 2 with a serial communication port and a number of input/ouput lines to exchange sensed signals and commands. The sensor 4 and the power management circuit 5 may be programmed to not respond to the presence of people who simply walk past the parking machine 1.

Further, the controller 2 may be programmed to place all peripherals including itself in the sleep mode as soon as the sensor 4 no longer senses the presence of a person at the parking machine 1. Thus after a user has finished operating the parking machine 1 and has left, all the peripherals, including the display 3, go into the sleep mode to save energy/power consumption. In this way, the processor 2 does not have to wait for a predetermined amount of time before placing the parking machine 1 in the sleep mode in order to make sure that the user is no longer at the parking machine 1.

The parking machine 1 is generally in a sleep mode when not activated by a user; this mode is a very low power mode, since all of the peripherals are shut down except for the presence sensor 4. Once the sensor 4 detects that a person, who may be a potential user, is approaching the parking machine 1, the controller 2 will wake-up the parking machine 1 placing it in its operating mode. In this manner, when a person arrives at the parking machine 1 it will be fully operational, the potential user will be greeted by a fully functioning display 3. The display 3 may indicate the times remaining for the parking spaces, which are controlled by the parking machine 1, as well as instructions for purchasing parking space time. A person just interested in verifying the correct time for her/his parking space may do so without having to interact with the parking machine at all. A person interested in buying parking space time will have the instructions for doing so, also immediately on arriving at the parking machine 1. Once the user is no longer in the front of the parking machine 1, the controller 2 blanks out the display 3 and returns the parking machine 1 to its sleep mode, conserving energy/battery power. In this manner, the requirement for “continuous display” is met since the display 3 is continuously energized from the time a person approaches the parking machine 1 to use it until the time the person leaves, and will not turn off even if a user hesitates for some time to operate the parking machine 1 while standing in front of it.

Therefore, a parking machine 1 may be operated effectively and efficiently by maintaining the parking machine 1 in a sleep mode, and then by placing the parking machine 1 in an operating mode when the presence of a person in the vicinity of the parking machine 1 is detected. This will allow the user to interact with the parking machine 1. The parking machine is then returned to the sleep mode once the person is no longer detected in the vicinity of the parking machine.

Among the advantages of the present invention, two advantages stand out. First, the parking machine can be left in its sleep (low power consumption) mode whenever it is not in use, which is a majority of the time, and will wake-up automatically when a user approaches and, second, the parking machine can be returned to the sleep mode sooner after a transaction since the parking machine 1 detects when there is no user present. The first advantage permits the parking machine 1 to save energy by being in the sleep mode most of the time while maintaining a flexible user-friendly display 3 interface. The second advantage provides for an extra saving of energy since the parking machine 1 can be returned to the sleep mode much more quickly not having to wait a predetermined period of time after a transaction is completed to make sure that a user is no longer present.

While the invention has been described according to what is presently considered to be the most practical and preferred embodiment, it must be understood that the invention is not limited to the disclosed embodiment. Those ordinarily skilled in the art will understand that various modifications and equivalent structures and functions may be made without departing from the spirit and scope of the invention as defined in the claims.

What is claimed is:

1. A method of operating a parking machine in a sleep mode when not activated, comprising:
a. detecting the presence of a person in the vicinity of the parking machine;
b. placing the parking machine into an operating mode;
c. receiving instructions from the person; and
d. returning the parking machine into the sleep mode once the person is no longer detected in the vicinity of the parking machine.

2. A method of operating a parking machine as claimed in claim 1 wherein step a. includes detecting the presence of the person for at least a predetermined short period of time.

3. A method of operating a parking machine having a controller and a display, and in a sleep mode when not activated, comprising:
a. detecting the presence of a person in the vicinity of the parking machine;
b. placing the display into an operating mode for displaying parking time and/or user instructions;
c. receiving instructions from the person; and
d. returning the display into the sleep mode once the person is no longer detected in the vicinity of the parking machine.

4. A method of operating a parking machine as claimed in claim 3 wherein step a. includes detecting the presence of the person for at least a predetermined short period of time.

5. A method of operating a parking machine as claimed in claim 4 wherein step b. includes placing other parking machine peripherals in the operating mode.

6. A method of operating a parking machine as claimed in claim 5 wherein step d. includes returning the display into the sleep mode a predetermined period of time after the person is no longer detected.

7. A method of operating a parking machine having a controller and a display, and in a sleep mode when not activated, comprising:
a. detecting the presence of a person in the vicinity of the parking machine;
b. placing the display into an operating mode for displaying parking time; and
c. returning the display into the sleep mode once the person is no longer detected in the vicinity of the parking machine.

8. A method of operating a parking machine as claimed in claim 7 wherein step a. includes detecting the presence of the person for at least a predetermined short period of time.

9. A method of operating a parking machine as claimed in claim 8 wherein step c. includes returning the display into the sleep mode a predetermined period of time after the person is no longer detected.

10. A parking machine in a sleep mode when not activated, comprising:
sensing means for detecting the presence of a person in the vicinity of the parking machine;
means for placing the parking machine into an operating mode;
means for receiving instructions from the person; and
means for returning the parking machine into the sleep mode once the person is no longer detected in the vicinity of the parking machine.

11. A parking machine as claimed in claim 10 wherein the sensing means includes means for detecting the presence of the person for at least a predetermined short period of time.

12. A parking machine having a controller and a display, and in a sleep mode when not activated, comprising:
sensing means for detecting the presence of a person in the vicinity of the parking machine;
means for placing the display into an operating mode for displaying parking time and/or user instructions;
means for receiving instructions from the person; and
means for returning the display into the sleep mode once the person is no longer detected in the vicinity of the parking machine.

13. A parking machine as claimed in claim 12 wherein the sensing means includes means for detecting the presence of the person for at least a predetermined short period of time.

14. A parking machine as claimed in claim 13 wherein the means for placing the display in the operating mode includes means for placing other parking machine peripherals in the operating mode.

15. A parking machine as claimed in claim 14 wherein means for returning the display into the sleep mode includes means for returning the display to the sleep mode a predetermined period of time after the person is no longer detected.

16. A parking machine comprising:
a controller;
a display controlled by the controller; and
presence sensor means coupled to the controller for detecting the presence of a person in the vicinity of the parking machine.

17. A parking machine as claimed in claim 16 comprising:
means within the controller for placing the display into a sleep mode when the presence of a person is not detected;
means within the controller for placing the display into an operating mode when the presence of a person is detected.

18. A parking machine as claimed in claim 16 wherein the display is an LCD.

19. A parking machine as claimed in claim 16 further comprising a number of peripherals coupled to the controller whereby the controller places the peripherals into the operating mode when the presence of a person is detected.
